(19) United States
(12) Patent Application Publication
(10) Pub. No.: US 2019/0236261 A1
(43) Pub. Date: Aug. 1, 2019

(54) SWIPE UNLOCKING METHOD, SYSTEM, AND ELECTRONIC DEVICE USING THE METHOD

(71) Applicant: Chiun Mai Communication Systems, Inc., New Taipei (TW)

(72) Inventor: CHIEN-HUNG CHENG, New Taipei (TW)

(21) Appl. No.: 16/252,682

(22) Filed: Jan. 20, 2019

(30) Foreign Application Priority Data
Jan. 20, 2018 (CN) 201810056215.3

(51) Int. Cl. G06F 21/36; G06F 3/0488

(52) U.S. Cl. CPC G06F 21/36; G06F 3/04883

(57) ABSTRACT

A swipe unlocking method depending on touch pressure as well as swiping direction includes detecting an unlocking request from a user and displaying a swipe unlocking interface on a display in response to the unlocking request; detecting touch points of continuous swipe operation operated on the swipe unlocking interface; determining whether a path of the touch points of continuous swipe operation is identical to a predetermined path and whether a touch pressure of the touch points of continuous swipe operation is identical to a predetermined rule; unlocking the electronic device when the path of the touch points of continuous swipe operation is identical to the predetermined path and the touch pressure of the touch points of continuous swipe operation is different from the predetermined rule; and otherwise remaining in a locking status. A swipe unlocking system and an electronic device are also provided.

### FIELD

The subject matter herein generally relates to data security and a method, a system, and an electronic device using swiping to unlock.

### BACKGROUND

Electronic devices may provide may many methods of unlocking, including methods of swiping to unlock. However, some methods of swiping to unlock may need only one finger of the user, or only simple swipes are needed to unlock. The simple swipes may cause unintended activation, and therefore unlocking or pausing the electronic device by mistake.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device.

FIG. 2 is a block diagram of one embodiment of a swipe unlocking system.

FIG. 3 is a flow chart of one embodiment of a swipe unlocking method.

FIG. 4 is diagram showing a first embodiment of a swiping path.

FIG. 5 is diagram showing a second embodiment of a swiping path.

FIG. 6 is diagram showing a third embodiment of a swiping path.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

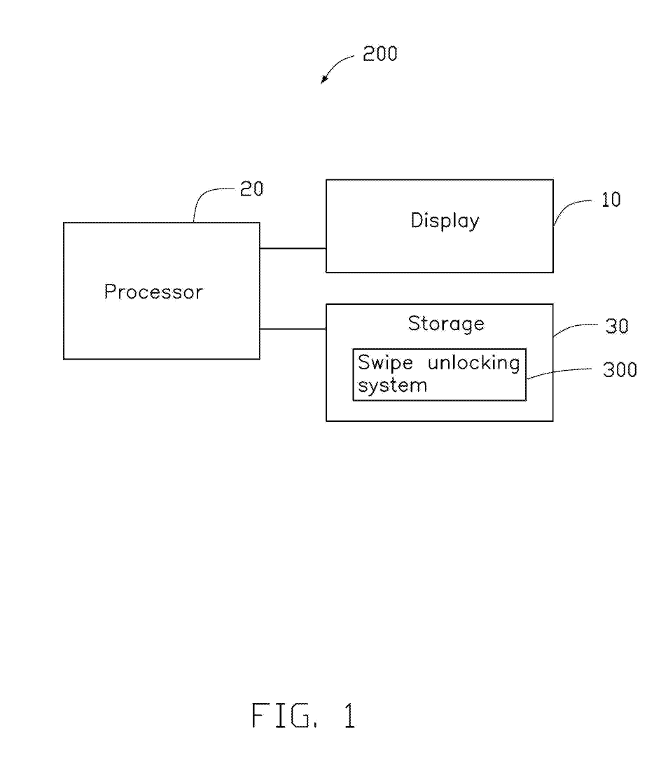

FIG. 1 illustrates one embodiment of an electronic device 200. The electronic device 200 can be, but is not limited to, a computer, a server computer, a tablet computer, a mobile phone, a personal digital assistant, a consumer electronic device, a distributed computing environment employing the aforesaid system, or other device. The electronic device 200 includes a display 10, a processor 20, and a storage 30. The display 10, processor 20, and the storage 30 are electrically connected to each other.

The display 10 is configured to provide a user interface for providing an interaction between the user and the electronic device 200. The display 10 can be operated by the user. The display 10 can be a pressure sensing touch display for detecting pressure on one or multiple positions. The display 10 may respond to pressure caused by any object, such as a stylus, an indicator, a pen, a finger, a hand and/or a fingernail, etc.

The processor 20 can be a central processing unit, a single chip microcomputer, or other micro integrated circuits.

The storage 30 can be a memory of the electronic device 200 or an external storage device, such as a Smart Media Card, a Secure Digital Card, or a Random-Access Memory (RAM), connected to the electronic device 200.

A swipe unlocking system 300 is applied and operated in the electronic device 200. The swipe unlocking system 300 includes one or multiple modules stored in the storage 30 and executed by the processor 20 in response to any swipe unlocking operation on the electronic device 200 by the user.

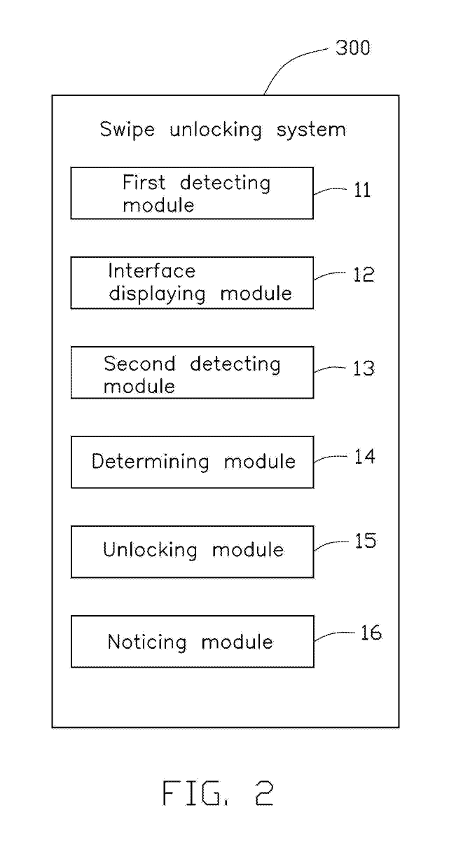

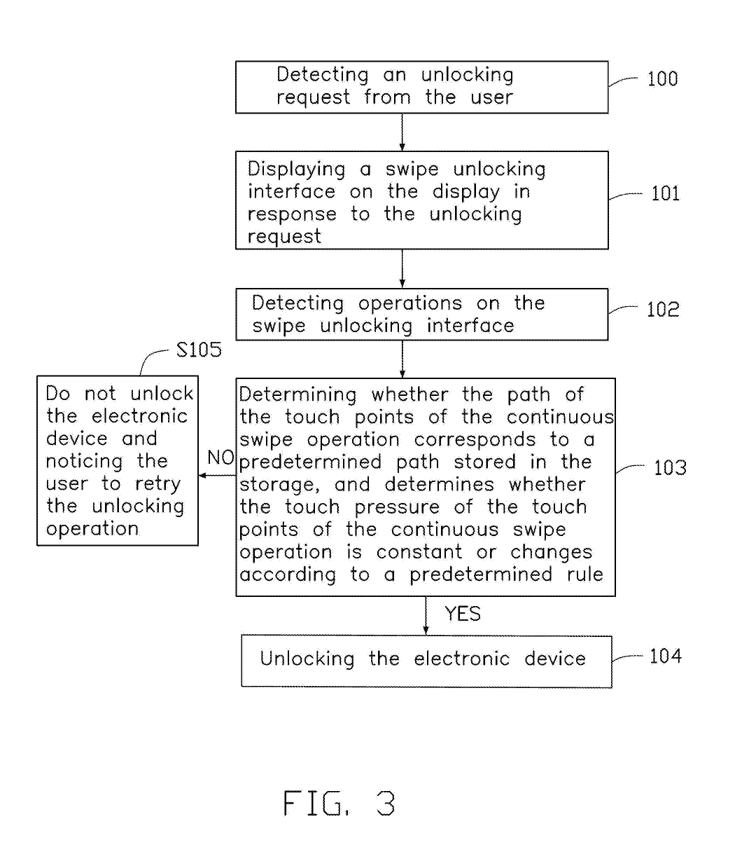

In FIG. 2, the swipe unlocking system 300 includes a first detecting module 11, an interface displaying module 12, a second detecting module 13, a determining module 14, an unlocking module 15, and a noticing module 16. In general, the word “module,” as used herein, refers to logic embodied in hardware or firmware, or to a collection of software instructions, written in a programming language, such as, Java, C, or Assembly. One or more software instructions in the modules may be embedded in firmware, such as erasable-programmable read-only memory (EPROM). The modules described herein may be implemented as either software and/or hardware modules and may be stored in any type of computer-readable medium or other storage device, the modules may be executed by any type of processor. Detailed functions of each module are described with reference to FIG. 3.

In FIG. 3, a flowchart is presented in accordance with an example embodiment which is being illustrated. The example swipe unlocking method can be carried out using the configurations illustrated in FIGS. 1 and 2, for example, and various elements of these figures are referenced in example method. Each block shown in FIG. 3 represents one or more processes, methods or subroutines, carried out in the method. Furthermore, the illustrated order of blocks is by example only and the order of the blocks can change. Additional blocks may be added or fewer blocks may be utilized, without departing from this disclosure. The method can begin at block 100.

At block 100, detecting an unlocking request from the user. The first detecting module 11 is configured to detect the unlocking request. The unlocking request can be a trigger of a predetermined button or a call reminder. In at least one embodiment, when the first detecting module 11 detects a trigger of the predetermined button, a determination may be made that an unlocking request is being made, and the procedure goes to block 101. Until a determination is made of a possible unlocking request, the procedure remains in block 100. The predetermined button can be a power button of the electronic device 200. When the power button is pressed, the first detecting module 11 can determine that an unlocking request may be being made.

At block 101, displaying a swipe unlocking interface on the display 10 in response to the unlocking request determined to be such. The swipe unlocking interface includes an unlocking pattern.

In at least one embodiment, the storage 30 stores the swipe unlocking interface. The swipe unlocking interface can be defined or preset by the user. The swipe unlocking interface can be presented as unlocking patterns like a grid, or a square or circular pattern.

In at least one embodiment, the interface displaying module 12 is configured to confirm a display position of the swipe unlocking interface according to the unlocking request, and trigger the display 10 to display the swipe unlocking interface in a certain relative position.

In another embodiment, the interface displaying module 12 is configured to confirm a display position of the swipe unlocking interface according to a resting position of the electronic device 200, and trigger the display 10 to display the swipe unlocking interface in a certain relative position. Preferably, the electronic device 200 includes a gyroscope or a gravity sensor configured to detect and output the resting position of the electronic device 200. The resting position of the electronic device 200 can be horizontal or vertical. The interface displaying module 12 confirms the display position of the swipe unlocking interface according to the resting position of the electronic device 200 as detected by the gyroscope or the gravity sensor. In this embodiment, the storage 30 stores predetermined positions corresponding to different resting positions of the electronic device 200 as defaults or as set by the user.

In at least one embodiment, the interface displaying module 12 is configured to confirm a display position of the swipe unlocking interface according to the unlocking request and the resting position of the electronic device 200, and trigger the display 10 to display the swipe unlocking interface correspondingly.

At block 102, the second detecting module 13 detects operations on the swipe unlocking interface. The operation is formed by continuously swiping from a point of touch. For instance, the user may use a finger or stylus to swipe on the display 10. The second detecting module 13 detects the operations and outputs characteristics of the operations. The operation characteristics include a touch pressure and a path of touch points of the continuous swipe operation. The touch points of the continuous swipe operation can be touch points between a starting point and a terminal point of a continuous touch operation without any break off by the finger or the stylus. The path of the touch points of the continuous swipe operation is a route of the continuous swipe operation on the swipe unlocking interface.

At block 103, the determining module 14 determines whether the path of the touch points of the continuous swipe operation corresponds to a predetermined path stored in the storage 30 of the electronic device 100, and determines whether the touch pressure of the touch points of the continuous swipe operation is constant or changes according to a predetermined rule. When the path of the touch points of the continuous swipe operation corresponds to the predetermined path and the touch pressure of the touch points of the continuous swipe operation is changed according to the predetermined rule, the procedure goes to block 104. When the path of the touch points of the continuous swipe operation is different to the predetermined path and/or the touch pressure of the touch points of the continuous swipe operation is not changed according to the predetermined rule, then it can be determined that the operation is not an unlocking operation and the procedure goes to block 105.

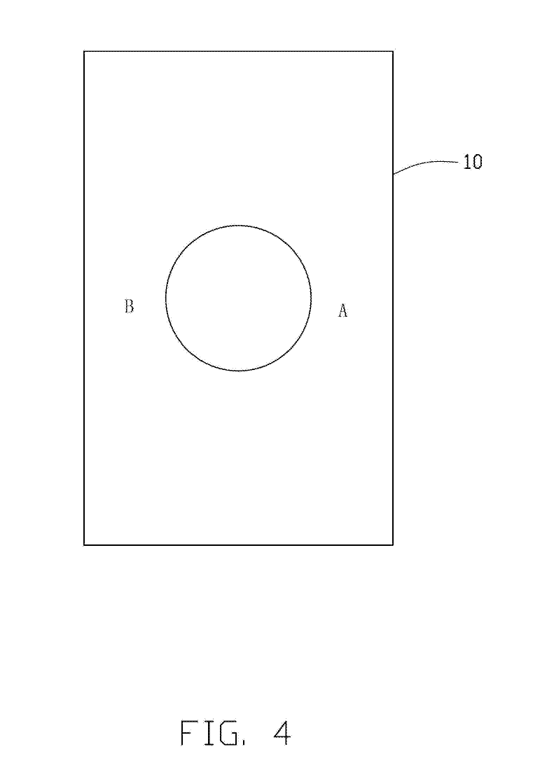

FIG. 4 shows a swipe unlocking interface including a circular pattern, the pattern includes points A and point B. The predetermined path is a circular path along a clockwise direction from the point point A. The predetermined path is formed by two sections, a first path section being a lower semi-circle from point A to point B, a second path section being an upper semi-circle from point B to point A, the two sections do not overlap. The predetermined rule may be that the touch pressure of the first path section is smaller than a predetermined value and the touch pressure of the second path section is greater than the predetermined value. When swiping from the point A, and the touch pressure from point A to point B is smaller than the predetermined value but the touch pressure from point B back to point A is greater than the predetermined value, then the determining module 14 determines that the operation is the unlocking operation, and the procedure goes to block 104. Otherwise, the determining module 14 determines that the operation is not an unlocking operation, the procedure goes to block 105.

In another embodiment, the predetermined path is same as previously described. The predetermined rule is that the touch pressure during the second path section (from point B back to point A) continuously increases. When so swiping, then the determining module 14 determines that the operation is the unlocking operation, and the procedure goes to block 104. Otherwise, the determining module 14 determines that the operation is not the unlocking operation, the procedure goes to block 105.

In FIG. 4, the predetermined path is tracing one and one half circles along an anticlockwise direction from the point A. The predetermined path can then comprise three sections. A first path section may be an upper semi-circle from point A to point B, a second path section is a lower semi-circle from point B to point A, and a third section is repeating an upper semi-circle from point A to point B immediately following the first and second path sections. The second path section has no overlapping with other two sections. The predetermined rule herein may be that the touch pressure of the second path section continuously increases but the touch pressure of the third section continuously decreases. In case of such swiping, the determining module 14 determines that the operation is the unlocking operation, and the procedure goes to block 104. Otherwise, the determining module 14 determines that the operation is not the unlocking operation, the procedure goes to block 105.

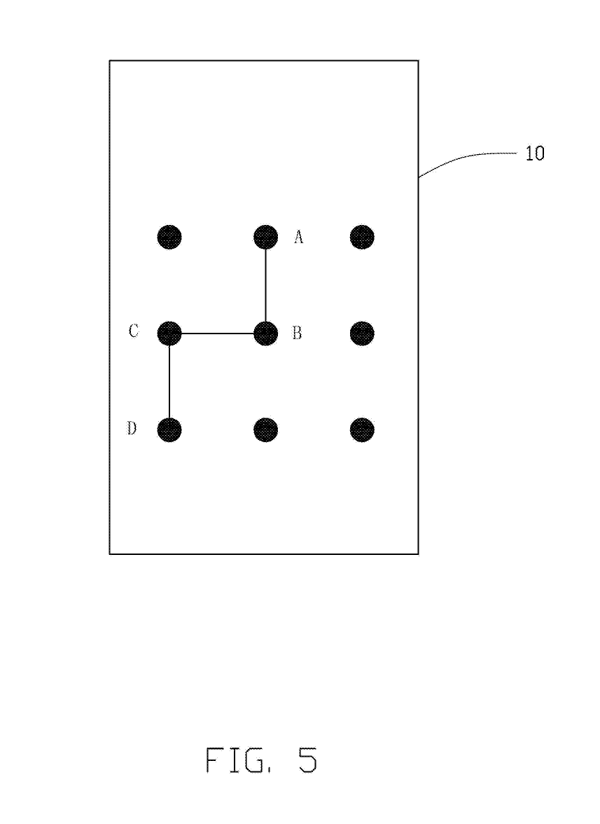

In FIG. 5, a swipe unlocking interface can include nine dots. The predetermined path is swiping through dots A, dot B, dot C, and dot D. The predetermined path is herein formed by three sections, a first path section being a line from dot A to dot B, a second path section being a line from dot B to dot C, and a third section being a line from dot C to dot D. The three sections have no overlapping. The predetermined rule is that the touch pressure of the second path section is greater than a predetermined value and that the touch pressures of the other two sections are smaller than the predetermined value. In case of such swiping, the determining module 14 determines that the operation is the unlocking operation, and the procedure goes to block 104. Otherwise, the determining module 14 determines that the operation is not the unlocking operation, and the procedure goes to block 105.

In another embodiment, the predetermined path is same as described in the paragraph before this and shown in FIG. 5. The predetermined rule is that the touch pressure of the first path section continuously decreases. When swiping from the dot A, and the touch pressure from the dot A to dot B continuously decreases but the touch pressure from the dot C to dot D is any pressure, then the determining module 14 determines that the operation is the unlocking operation, the procedure goes to block 104. Otherwise, the determining module 14 determines that the operation is not the unlocking operation, the procedure goes to block 105.

In another embodiment, the swipe unlocking interface is same as shown in FIG. 5. The predetermined path is swiping through dots A, B, C, and D and swiping back to dot C without interruption. The predetermined path herein is formed by four sections, a first path section being a line from dot A to dot B, a second path section being a line from dot B to dot C, a third section being a line from dot C to dot D, and a fourth section being a line from dot D back to dot C. The third section and the fourth section are overlapped but are in opposite directions on the swipe unlocking interface. The predetermined rule can be that the touch pressure of the third section continuously increases and the touch pressure of the fourth section continuously decreases. In case of such swiping, the determining module 14 determines that the operation is the unlocking operation, and the procedure goes to block 104. Otherwise, the determining module 14 determines that the operation is not an unlocking operation, and the procedure goes to block 105.

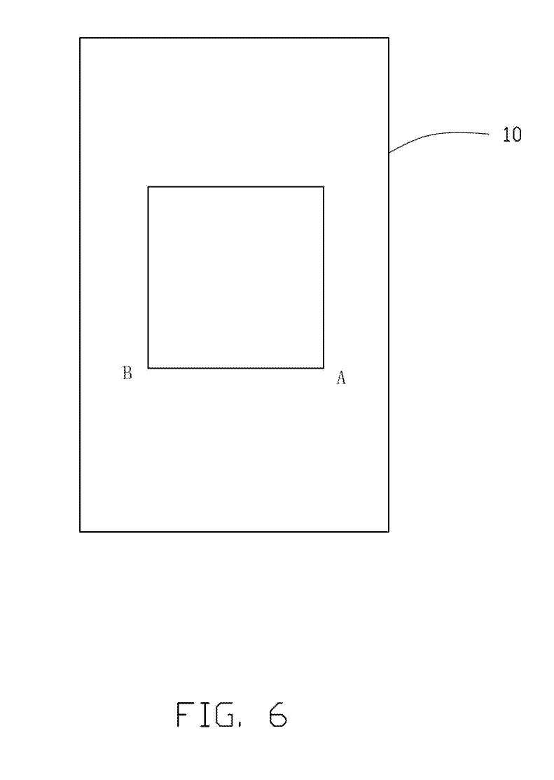

In FIG. 6, a swipe unlocking interface can include a rectangular pattern. The swipe unlocking interface shown in FIG. 6 is similar with the swipe unlocking interface shown in FIG. 4, excepting the rectangular pattern in FIG. 6 replaces the circular pattern in FIG. 4 and the points A and B are on a lower right corner and a lower left corner of the rectangular pattern. The predetermined path and the predetermined rule in this embodiment can be similar to those of the embodiment in FIG. 4.

At block 104, the unlocking module 15 unlocks the electronic device 200.

At block 105, the unlocking module 15 does not unlock the electronic device 200, the noticing module 16 warns the user to retry the unlocking operation. The warning can be an audio message or a text message displayed on the display 10. The audio message and the text message can be predetermined.

The electronic device 200 warns the user to retry the unlocking operation through the audio message or the text message.

The swipe unlocking method, system, and the electronic device 200 provides the swipe unlocking interface to receive touch points of the continuous swipe operation. When the path of the touch points of the continuous swipe operation is identical to the predetermined path and the touch pressure during the touch points of the continuous swipe operation is identical to the predetermined rule, then unlocking of the electronic device 200 takes place. Swipe unlocking method, system, and the electronic device 200 improves security.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A swipe unlocking system, applied in an electronic device having a display, the swipe unlocking system is stored in a storage and executed by a processor of the electronic device, the swipe unlocking system causes the processor to:
detect an unlocking request from a user;
display a swipe unlocking interface on the display in response to the unlocking request;
detect touch points of a continuous swipe operation operated on the swipe unlocking interface;
determine whether a path of the touch points of the continuous swipe operation is identical to a predetermined path storage in the electronic device and whether a touch pressure of the touch points of the continuous swipe operation is identical to a predetermined rule stored in the electronic device; and
unlock the electronic device if the path of the touch points of the continuous swipe operation is identical to the predetermined path stored in the electronic device and the touch pressure of the touch points of the continuous swipe operation is identical to the predetermined rule stored in the electronic device; and
remain the electronic device in a locking status if the path of the touch points of the continuous swipe operation is different from the predetermined path stored in the electronic device and/or the touch pressure of the touch points of the continuous swipe operation is different from the predetermined rule stored in the electronic device.

2. The swipe unlocking system as claimed in claim 1, wherein the predetermined path comprises a first path section and a second path section, the first path section and the second path section are overlapped in the swipe unlocking interface, the touch points of the continuous swipe operation are in the same direction or in the opposite direction.

3. The electronic device as claimed in claim 2, wherein the predetermined rule is the touch pressure of the first path section smaller than a predetermined value and the touch pressure of the second path section greater than the predetermined value.

4. The electronic device as claimed in claim 2, wherein the predetermined rule is the touch pressure of the first path section continuously increases or continuously decreases.

5. A swipe unlocking method applied in an electronic device, the electronic device having a display, the swipe unlocking method comprising:
detecting an unlocking request from a user;
displaying a swipe unlocking interface on the display in response to the unlocking request;
detecting touch points of a continuous swipe operation operated on the swipe unlocking interface;
determining whether a path of the touch points of the continuous swipe operation is identical to a predetermined path stored in the electronic device and whether a touch pressure of the touch points of the continuous swipe operation is identical to a predetermined rule stored in the electronic device; and
unlocking the electronic device if the path of the touch points of continuous swipe operation is identical to the predetermined path stored in the electronic device and the touch pressure of the touch points of continuous swipe operation is identical to the predetermined rule stored in the electronic device; and
remaining the electronic device in a locking status if the path of the touch points of continuous swipe operation is different from the predetermined path stored in the electronic device and/or the touch pressure of the touch points of continuous swipe operation is different from the predetermined rule stored in the electronic device.

6. The swipe unlocking method as claimed in claim 5, wherein the predetermined path comprises a first path section and a second path section, the first path section and the second path section are overlapped in the swipe unlocking interface, the continuous swipe operation of the first path section and the second path section are in the same direction or in the opposite direction.

7. The swipe unlocking method as claimed in claim 6, wherein the predetermined rule is the touch pressure of the first path section smaller than a predetermined value and the touch pressure of the second path section greater than the predetermined value.

8. The swipe unlocking method as claimed in claim 6, wherein the predetermined rule is the touch pressure of the first path section continuously increases or continuously decreases.

9. An electronic device comprising:
a display;
a storage;
at least one processor; and
at least one module stored in the storage and executed by the processor, the at least one module comprising:
a first detecting module configured to detect an unlocking request from a user;
an interface displaying module configured to display a swipe unlocking interface on the display in response to the unlocking request;
a second detecting module configured to detect touch points of a continuous swipe operation operated on the swipe unlocking interface;
a determining module configured to determine whether a path of the touch points of continuous swipe operation is identical to a predetermined path storage in the electronic device and whether a touch pressure of the touch points of the continuous swipe operation is identical to a predetermined rule stored in the electronic device; and
an unlocking module configured to unlock the electronic device if the path of the touch points of continuous swipe operation is identical to the predetermined path stored in the electronic device and the touch pressure of the touch points of continuous swipe operation is identical to the predetermined rule stored in the electronic device; and remain the electronic device in a locking status if the path of the touch points of continuous swipe operation is different from the predetermined path stored in the electronic device and/or the touch pressure of the touch points of the continuous swipe operation is different from the predetermined rule stored in the electronic device.

10. The electronic device as claimed in claim 9, wherein the predetermined path comprises a first path section and a second path section, the first path section and the second path section are overlapped in the swipe unlocking interface, the touch points of the continuous swipe operation are in the same direction or in the opposite direction.

11. The electronic device as claimed in claim 10, wherein the predetermined rule is the touch pressure of the first path section smaller than a predetermined value and the touch pressure of the second path section greater than the predetermined value.

12. The electronic device as claimed in claim 10, wherein the predetermined rule is the touch pressure of the first path section continuously increases or continuously decreases.
